(19) United States
(12) Patent Application Publication
(10) Pub. No.: US 2015/0326489 A1
(43) Pub. Date: Nov. 12, 2015

(54) NON-TRANSITORY COMPUTER-READABLE RECORDING MEDIUM HAVING STORED THEREIN RESOURCE DISPLAYING PROGRAM, INFORMATION PROCESSING APPARATUS, AND METHOD FOR DISPLAYING RESOURCE

(71) Applicant: FUJITSU LIMITED, Kawasaki-shi (JP)

(72) Inventors: Masaki GAKE, Yokohama (JP); Kadohito Ohsuga, Numazu (JP); Masaki Nakajima, Numazu (JP)

(21) Appl. No.: 14/688,095

(22) Filed: Apr. 16, 2015

(30) Foreign Application Priority Data
May 8, 2014 (JP) 2014-096751

(51) Int. Cl. H04L 12/911; H04L 12/26; G06F 3/0481; G06T 11/20

(52) U.S. Cl. CPC H04L 47/70; G06T 11/20; H04L 43/045; G06F 3/0481

(57) ABSTRACT

The corresponding between resources of two different displaying category can be easily grasped by: inputting an assignment of a focused resource; specifying one or more relative resources which are related to the focused resource and which belong to the second displaying category by referring to resource information recording a plurality of resources belonging to a first displaying category and a plurality of resources belonging to a second displaying category of the information processing system in association with each other, using the focused resource; and emphasizing the specified relative resources in a first resource map, the first resource map being displayed on a displaying device and coupling the plurality of resources belonging to the second displaying category.

### CROSS-REFERENCE TO RELATED APPLICATION

This application is based upon and claims the benefit of priority of the prior Japanese Patent application No. 2014-096751, filed on May 8, 2014, the entire contents of which are incorporated herein by reference.

### FIELD

The embodiment discussed herein is directed to a non-transitory computer-readable recording medium having stored therein a resource displaying program, an information processing apparatus, and a method for displaying a resource.

### BACKGROUND

In recent years, a management system that manages a network system in which computers such as servers and network devices such as switches are connected via a Local Area Network (LAN) has come to be known.

Such a management system has, for example, a function of displaying a physical map that visualizes the system configuration from the viewpoint of the physical configuration and a function of displaying a logical map that visualizes the system configuration from the viewpoint of the logical configuration.

FIGS. 14A, 14B, and 14C illustrate an example of a physical map of a network system. FIG. 14A illustrates the upper configuration of the network system; FIG. 14B illustrates a lower configuration of a part of FIG. 14A; and FIG. 14C is a lower configuration of a part of FIG. 14B. FIGS. 15A and 15B illustrate an example of a logical map of the same network system as that of FIGS. 14A, 14B, and 14C. FIG. 15A illustrates the upper configuration of the network system; and FIG. 15B illustrates a lower configuration of a part of FIG. 15A.

A management system displays the physical map exemplified by FIGS. 14A-14C on a non-illustrated display so that a system manager or the like can easily grasp the physical configuration of the network system.

In a physical map, each physical resource included in a network system is displayed in the form of an icon. Icons are displayed in a state of being connected to each other according to the physical connection of the corresponding resources.

When the operator selects a resource of which the operator wishes to display details on the physical map illustrated in FIG. 14A, one or more lower (lower-layer) physical resources forming the selected resource are displayed. If the operator selects “chassis” in the example of FIG. 14A, vmh1, vmh2 and bsw1, bsw2 that are mounted on the selected chassis are displayed (expanded) as illustrated in FIG. 14B. Here, the term “vmh” represents a virtual machine host; and the term “bsw” represents a blade switch.

Then, if the operator further selects vmh1 in the example of FIG. 14B, the lower physical resources that forms the vmh1 are expanded as illustrated in FIG. 14C.

The logical map illustrated in FIGS. 15A and 15B is obtained by visualizing the network system that has the configuration illustrated in FIGS. 14A-14C from the viewpoint of the logical configuration.

The management system displays the logical map exemplified by FIGS. 15A-15B on a non-illustrated display so that the system manager or the like can easily grasp the logical configuration of the network system. In the logical map illustrated in FIG. 15A, a virtual system is displayed in the form of an icon with the letters “l-platform”.

When the operator selects a logical resource (virtual system) of which the operator wishes to display details on the logical map displayed on a displaying device of the management system, one or more lower (lower-layer) logical resources forming the selected virtual system are displayed as illustrated in FIG. 15B.

[Patent Literature] Japanese Laid-open Patent Publication No. 2011-113571

Such a conventional management system has difficulty in easily grasping the correspondence between a physical resource and a logical system. For example, providing that a problem occurs in a particular physical resource, it is difficult to grasp that the problem affects which range of the logical resource.

### SUMMARY

According to an aspect of the embodiment, a non-transitory computer-readable recording medium having stored therein a resource displaying program causing a computer to execute a process including: inputting an assignment of a resource belonging to a first displaying category to be focused among a plurality of resources belonging to each of a plurality of displaying categories, including the first displaying category and a second displaying category, to a focused resource, the first and the second displaying categories included in an information processing system; specifying one or more relative resources which are related to the focused resource and which belong to the second displaying category by referring to resource information recording the plurality of resources belonging to the first displaying category and the plurality of resources belonging to the second displaying category of the information processing system in association with each other, using the focused resource; and emphasizing the specified relative resources in a first resource map, the first resource map being displayed on a displaying device and connecting the plurality of resources belonging to the second displaying category.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating the entire configuration of a management system according to an example of an embodiment;

FIGS. 2A, 2B, and 2C are diagrams illustrating examples of a physical map of a network system managed by a management system of the embodiment;

FIG. 3 is a diagram illustrating an example of a logical map of a network system managed by a management system of an example of the embodiment;

FIG. 4 is a diagram depicting an example of a displaying resource management table of a management system of an example of the embodiment;

FIG. 5 is a diagram illustrating an example of an input screen displayed in the management system of an example of the embodiment;

FIGS. 6A and 6B are diagrams illustrating examples of a resource map displayed in a management system of an example of the embodiment;

FIGS. 7A and 7B are diagrams illustrating examples of an inputting screen displayed in a management system of an example of the embodiment;

FIGS. 8A and 8B are diagrams illustrating examples of a resource map displayed in a management system of an example of the embodiment;

FIG. 9 is a flow diagram denoting a succession of procedural steps of controlling displaying of a selector screen by a displaying controller in a management system of an example of the embodiment;

FIG. 10 is a flow diagram denoting a succession of procedural steps of controlling displaying of a resource map by a displaying controller in a management system of an example of the embodiment;

FIG. 11 is a flow diagram denoting a succession of procedural steps of controlling displaying of a resource map by a displaying controller when the layer is to be switched in a management system of an example of the embodiment;

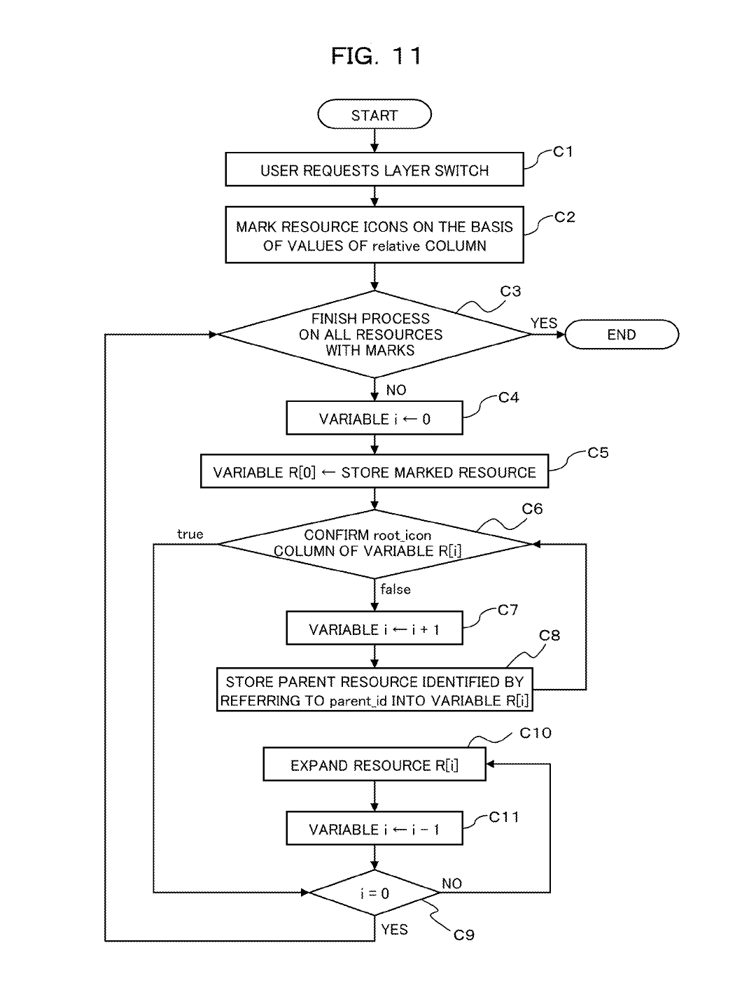

FIG. 12 is a diagram depicting a first modification to a displaying resource management table of a management system of an example of the embodiment;

FIG. 13 is a diagram depicting a second modification to a displaying resource management table of a management system of an example of the embodiment;

FIGS. 14A, 14B, and 14C are diagrams illustrating an example of a physical map of a network system; and

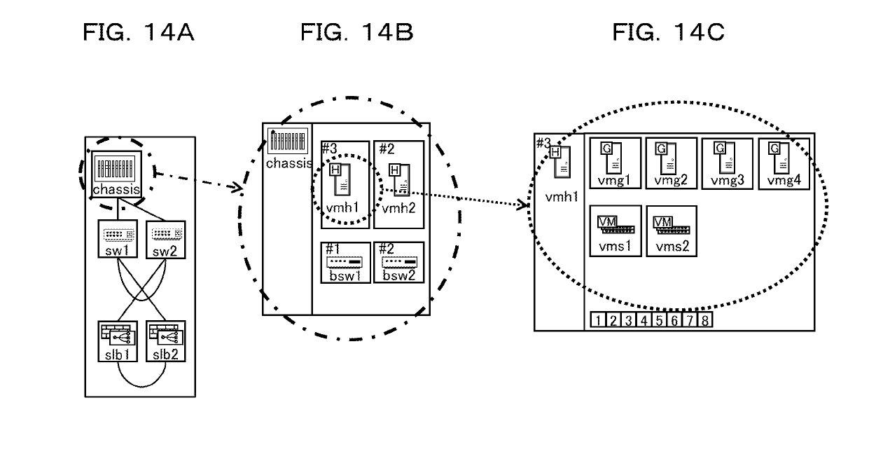

FIGS. 15A and 15B are diagram illustrating an example of a logical map of the network system illustrated in FIGS. 14A, 14B, and 14C.

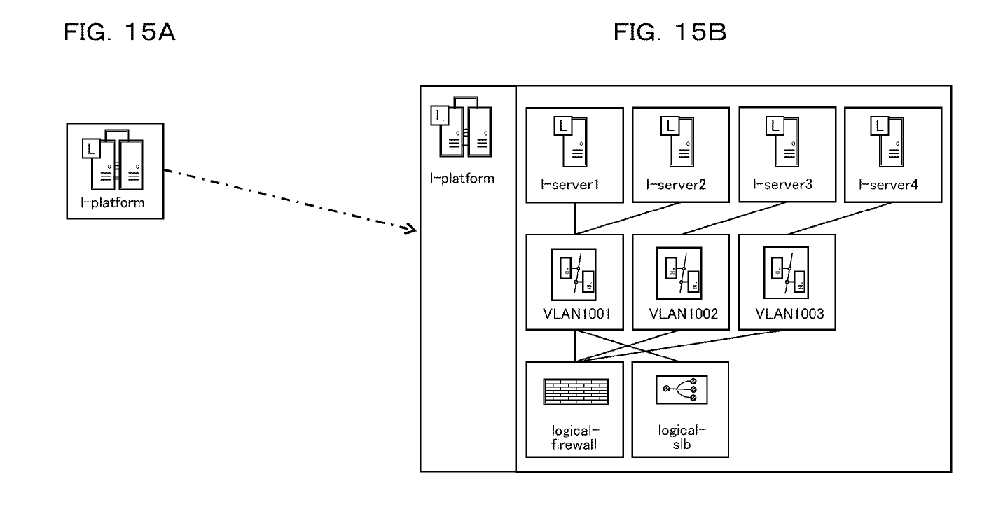

### DESCRIPTION OF EMBODIMENT

Hereinafter, description will now be made in relation to a non-transitory computer-readable recording medium having stored therein a resource displaying program, an information processing apparatus, and a method for displaying a resource with reference to the accompanying drawings. However, the following embodiment is merely exemplary and has no intention to exclude various modification and application of techniques that are not explained throughout the description. In other words, various changes and modifications are suggested without departing from the spirit of the modification (for example, a combination of the embodiments and modifications). The accompanying drawings means that only the components appearing therein are included, but additional component and functions can be of course included.

(A) Configuration:

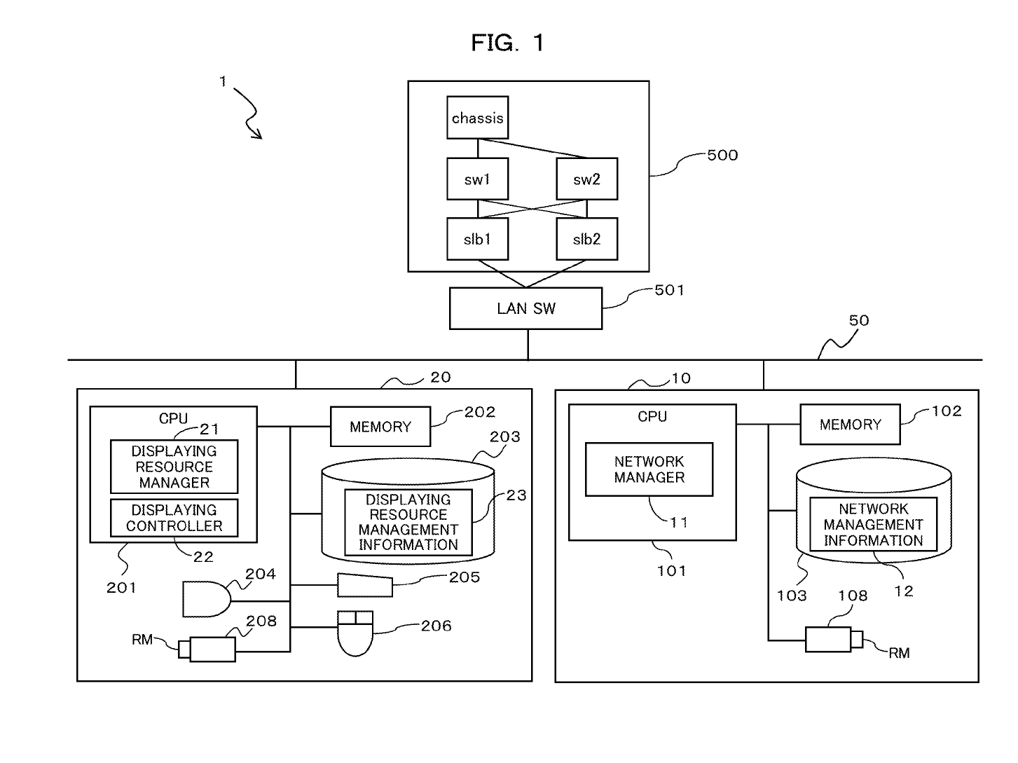

FIG. 1 is a block diagram illustrating an example of the entire configuration of a management system 1 according to an example of an embodiment. The management system 1 manages the network system 500 communicably connected thereto via a LAN (communication line) 50, and is capable of, for example, managing the state of the network system 500 and setting the environment of the network system 500. As illustrated in FIG. 1, the management system 1 includes a management server 10, a management terminal (information processing apparatus) 20, and the LAN 50, and is connected to the network system 500 that is to be managed via a Local Area Network (LAN) switch 501.

The LAN switch 501 is a relay that connects the network system 500 to the LAN 50, and relays data transmission and reception among the network system 500, the management server 10, and the management terminal 20. Various existing network relays can be applied to the LAN switch 501, so detailed description thereof is omitted here.

The network system 500 is an information processing system including multiple network devices connected to each other via communication lines.

The network system 500 can be illustrated in the form of resource map (first resource map, second resource map) by expressing the components (resource) included in the network system 500 with icons and further connecting the icons.

Hardware components, such as a network device, included in the network system 500 may sometimes be referred to as physical resources. Conversely, in expressing the network system 500 in the logical configuration, the logical components may sometimes be referred to as logical resources.

A resource map visualizing the network system 500 from the viewpoint of the physical configuration is referred to as a physical map, and a resource map visualizing the network system 500 from the viewpoint of the logical configuration is referred to as a logical map.

In other words, the physical map expresses the network system 500 in the physical layer while the logical map expresses the network system 500 in the logical layer.

As the above, the network system 500 can be alternatively expressed in two kinds of displaying category (resource category, layer) representing the physical configuration and the logical configuration.

Here, a displaying category is a category which is selectively displayed. In this embodiment, one category is alternatively selected from two displaying categories of the logical configuration and the physical configuration, and, depending on the result of the selection, the physical map or the logical map is displayed on the displaying device 204 of the management terminal 20 that is to be detailed below.

Selection of either displaying category from the physical configuration and the logical configuration causes the management terminal 20 to selectively display the resources belonging to the selected displaying category on the displaying device 204.

If the physical configuration is selected as the displaying category, the physical map is displayed on the displaying device 204. In contrast, if the logical configuration is selected as the displaying category, the logical map is displayed on the displaying device 204. This means that the physical map of the logical map is exclusively displayed on the displaying device 204 depending on the selected displaying category.

As to be detailed below, the management terminal 20 can select an arbitrary resource among multiple resources belonging to the physical configuration or the logical configuration as a focused resource.

In regard to the displaying category, a physical resource belongs to the physical configuration while a logical resource belongs to the logical configuration.

The physical map (physical network) is obtained by connecting the physical resources included in the network system 500 likewise the actual connection by the communication lines.

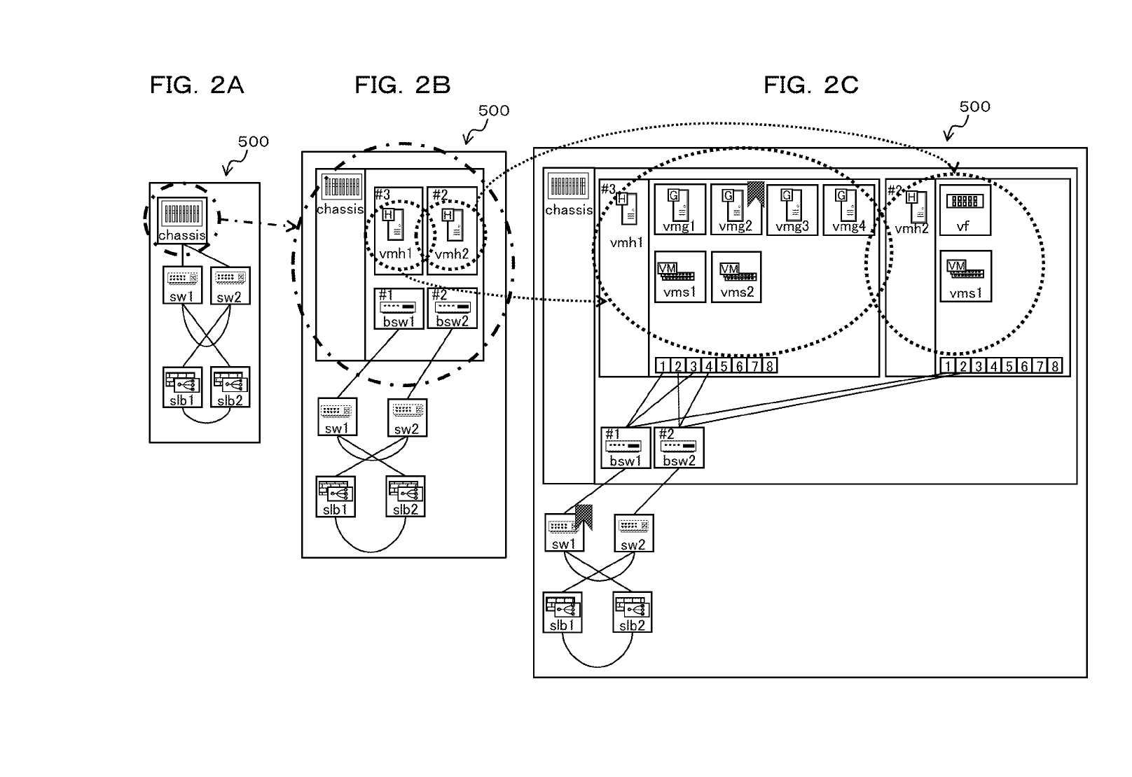

The network system 500 may have any configuration and is exemplified by the configuration as illustrated in FIGS. 2A, 2B, and 2C.

FIGS. 2A, 2B, and 2C are diagrams illustrating examples of the physical map of the network system 500 managed by the management system 1. FIG. 2A illustrates the upper configuration of the network system 500; FIG. 2B illustrates a detailed lower configuration of a part of FIG. 2A; and FIG. 2C illustrates a detailed lower configuration of a part of FIG. 2B.

An example of the network system 500 illustrated in FIG. 2A includes a chassis (i.e., casing), switches 1, 2 (sw1, sw2), and server load balancers 1, 2 (slb1, slb2). The slb1 and the slb 2 are connected to the chassis via the sw2 and the sw1, respectively.

The network system 500 has a layer configuration. As illustrated in FIG. 2B, virtual machine hosts 1, 2 (vmh1, vmh2) and blade switches 1, 2 (bsw1, bsw2) are included in the chassis.

In this configuration relationship, the vmh1, the vmh2, the sw1, and the sw2 included in the chassis are lower components (lower layer) when seen from the chassis while the chassis is an upper component (upper layer) when seen from the vmh1, the vmh2, the sw1, and the sw2.

Hereinafter, a resource of a lower layer seen from the upper layer thereof may sometimes be referred to as a child resource, and in contrast, a resource of an upper layer seen from the lower layer thereof may sometimes be referred to as a parent resource.

Hereinafter, displaying one or more resources of a lower layer of a particular resource of the upper layer under states where the resources of the upper layer are being displayed may sometimes be referred to as “expanding a resource” or “ expanding a resource map (more specifically, a physical map or a logical map)”.

For example, FIG. 2B illustrates a state where the chassis of FIG. 2A is expanded, and FIG. 2C illustrates a state where the vmh1 and the vmh2 of FIG. 2B are expanded.

The vmh1 and the vmh2 may sometimes be referred to as a vmh #3 and a vmh #2, respectively. The bsw1 and the bsw2 may sometimes be referred to as a bsw #1 and a bsw #2, respectively.

As illustrated in FIG. 2C, the vmh1 further includes virtual machine guests 1-4 (vmg1 to vmg4) and virtual machine switches 1, (vms1, vms2). The vmh2 includes a virtual firewall (vf) and a vms1. The vmh1 and the vmh2 are connected to the sw1 and sw2 via the bsw1 and the bsw2.

Abstraction of the respective physical resources included in the network system 500 by using a known platform virtualizing function achieves the logical resources.

Through the platform virtualization, the host program (control program) generates pseudo computer environment on the hardware platform and provides guest software with a virtual machine.

Any known platform virtualizing functions can be applied and the detailed description thereof is omitted here.

In the example illustrated in FIG. 2C, some icons are marked with ribbons. This marking will be detailed below.

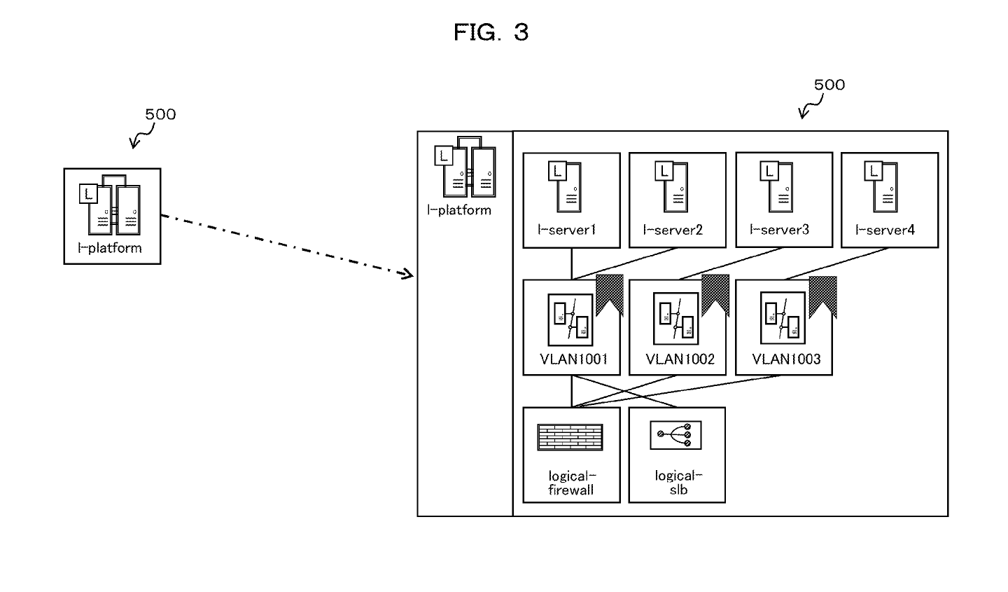

The logical map (logical network) is obtained by connecting the logical resources included in the network system 500 likewise the actual logical configuration. The network system 500 is expressed in the logical map of FIG. 3.

FIG. 3 is a diagram illustrating an example of a logical map of the network system 500 managed by the management system 1 of an example of this embodiment.

In FIG. 3, the network system 500 is expressed as a virtual system having a logical configuration by icons with the letters “l-platform”.

The network system 500 of FIG. 3 includes one or more (four in the example of FIG. 3) logical servers 1-4 and one or more (three in the example of FIG. 3) VLANs 1001-1003, a logical-firewall, and a logical-slb.

In FIG. 3, each logical server is represented by an icon with the letters “l-server”.

Also in the example of FIG. 3, some icons are marked with ribbons. This marking will be detailed below.

The network system 500 having the hardware configuration illustrated in FIG. 2 is provided, to a user, in the form of the configuration having four servers (logical-servers) 1-4, the logical-firewall, and the logical-slb that are connected via a virtual LAN as illustrated in FIG. 3.

Various services such as web services, application services, and database services are executed in the logical-servers 1-4 and are provided to a user.

The management server 10 manages the configuration of the network system 500, and manages the physical resources and the logical resources of the network system 500. An example of the management server 10 is an information processing apparatus (computer) having a server function, and as illustrated in FIG. 1, includes a Central Processing Unit (CPU) 101, a memory 102, a storing device 103, and a medium reader 108.

The storing device 103 is exemplified by a Hard Disk Drive (HDD) or a Solid State Drive (SSD) and stores therein various kinds of data. For example, network management information 12, which is the information to achieve the above platform virtualizing function, is stored in the storing device 103. The network management information 12 includes, for example, information about the physical resources and the logical resources of the network system 500.

The memory 102 is a storing device including a ROM and a RAM. In the ROM of the memory 102, a software program for the network management and data for the program are written. The software program stored in the memory 102 is appropriately read by the CPU 101, which then executes the program. The RAM of the memory 102 is used as a main memory or a working memory.

The CPU 101 is a processing device that carries out various controls and calculations, and achieves various functions by executing the program stored in the memory 102.

This means that the CPU 101 has a function as a network manager 11. Here, the network manager 11 manages the network system 500 and achieves the above platform virtualizing function. The network manager 11 may be achieved by any known technique, and detailed description thereof is omitted here.

The CPU 101 presents the information of the physical resource or the logical resource of the network system 500 to the management terminal 20 in response to a request for displaying resource information input from the management terminal 20.

The medium reader 108 is configured to be able to mount a recording medium RM thereon. The medium reader 108 is configured to be able to read information stored in a recording medium RM when the recording medium RM is mounted thereon. A recording medium of the illustrated embodiment is portable. The recording medium RM is a computer-readable recording medium and is exemplified by a flexible disk, a CD (e.g., CD-ROM, CD-R, CD-RW), a DVD (e.g., DVD-ROM, DVD-RAM, DVD-R, DVD+R, DVD-RW, DVD+RW, HD DVD), a Blu-ray disk, a magnetic disk, an optical disk, a magneto-optical disk, and a semiconductor memory.

The management terminal 20 is a terminal device through which the operator such as a system manager operates the management system 1. The management terminal 20 inputs, for example, various information pieces and instructions into the management server 10 and outputs various information pieces notified from the management server 10.

The management terminal 20 is an information processing apparatus (computer) and as illustrated in FIG. 1, includes a CPU 201, a memory 202, a storing device 203, a displaying device 204, a keyboard 205, a mouse 206, and a medium reader 208.

The displaying device 204 displays thereon various pieces of information, and is exemplified by a Liquid Crystal Display or a Cathode Ray Tube (CRT) display. However, the displaying device 204 is not limited to the above examples, and may be a luminescent displaying device (e.g., a light emitting diode (LED) display, an organic electroluminescent display), electronic paper (e.g., cholesteric liquid crystal display, electrophoretic display), a Digital Micromirror Device (DMD), a PDP (Plasma Display Panel), and a Field Emission Display (FMD). Other displaying device snot described here can also be suggested.

On the displaying device 204, resource information of the network system 500 is displayed.

The mouse 206 and the keyboard 205 are input devices operated by the operator to make various inputs.

In response to an input operation by the operator using the mouse 206 and/or the keyboard 205, the resource information of the network system 500 is displayed on the displaying device 204. This means that the management terminal 20 achieves a resource information displaying function (resource displaying function) that displays the resource information of the network system 500.

The medium reader 208 is configured to be able to mount the above recording medium RM thereon. The medium reader 208 is configured to be able to read information stored in a recording medium RM when the recording medium RM is mounted thereon.

The storing device 203 is exemplified by an HDD or an SSD and stores therein various kinds of data. For example, in the storing device 203, displaying resource management information 23 that is to be detailed below is stored. The displaying resource management information 23 is expanded into a table form in the CPU 201 that is to be detailed below and used by the CPU 201.

The memory 202 is a storing device including a ROM and a RAM. In the ROM of the memory 202, a software program for a resource displaying function and data for the program are written. The software program stored in the memory 202 is appropriately read by the CPU 201, which then executes the program. The RAM of the memory 202 is used as a main memory or a working memory.

The CPU 201 is a processing device that carries out various controls and calculations, and achieves various functions by executing a program stored in the memory 202. This means that the CPU 201 achieves the above resource information displaying function by functioning as a displaying resource manager 21 and a displaying controller 22.

The program (resource displaying program) to achieve the functions of the displaying resource manager 21 and the displaying controller 22 is provided in the form of being stored in the above recording medium RM. The computer reads the program from the recording medium RM; forwards the read program to an internal storing device or an external storing device, which stores therein the program; and uses the program. Alternatively, the program may be stored in a storing device (recording medium) such as a magnetic disk, an optical disk, or a magneto-optical disk, and may be provided from the storing device to the computer through the communication path.

In achieving the functions of the displaying resource manager 21 and the displaying controller 22, the microprocessor (in this example, the CPU 201) of the computer executes the program stored in an internal storing device (in this example, the RAM or the ROM of the memory 202). In this event, the computer may read the program stored in the recording medium and execute the read program.

The displaying resource manager 21 manages information to be used for displaying the resource information of the network system 500.

The displaying resource manager 21 manages the displaying resource management information (resource information) 23. The displaying resource management information 23 records the physical resources and the logical resources that form the network system 500 in association with each other.

For example, the CPU 201 reads the displaying resource management information 23 and expands the read information into a table form. Therefore, the displaying resource management information 23 is sometimes referred to as a displaying resource management table 23.

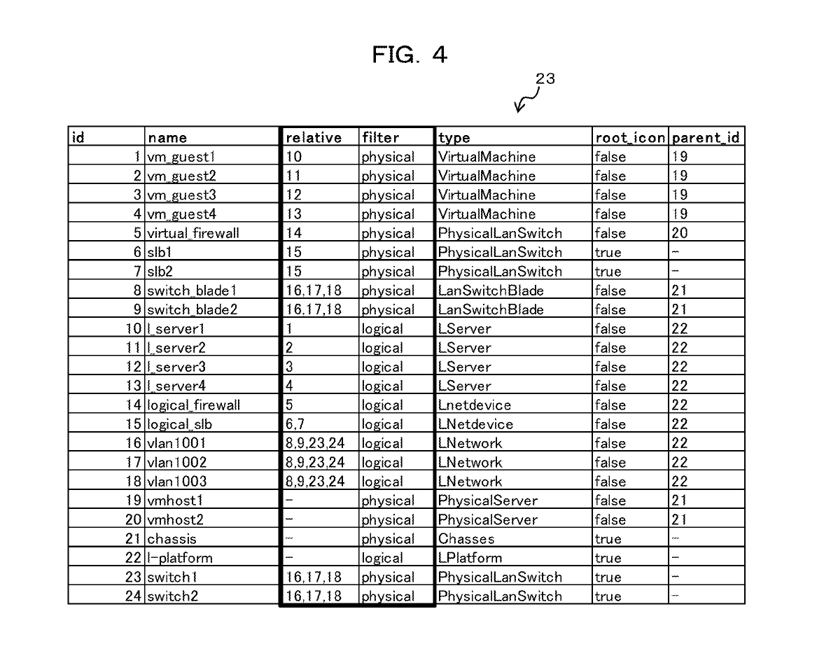

FIG. 4 is a diagram illustrating an example of the displaying resource management table 23 of the management system 1 of an example of this embodiment.

The displaying resource management table 23 manages information of each of the resources forming the network system 500. As illustrated in FIG. 4, the displaying resource management table 23 includes columns of id, name, relative, filter, type, root_icon, and paretnt_id for each resource and associates the information of the respective columns with one another.

Here, the “id” column stores therein the identification (id) information to identify each subject resource (record) registered in the displaying resource management table 23. In the example of FIG. 4, an id is a sequential integer.

The “name” column stores therein the name of the subject resource. For example, the resources “vm_guest1” to “vm_guest4”, which are respectively registered to be the id “1” to the id “4” in the displaying resource management table 23, are expressed with the icons represented by symbols vmg1 to vmg4 in the physical map of, for example, FIG. 2C, respectively. The resources of “switch_blade1”, “switch_blade2”, which are respectively registered to be the id “8” and id “9”, are expressed with the icons represented by symbols bsw1 and bsw2 in the physical map of, for example, FIG. 2B, respectively.

The “type” column stores therein information representing the device type of the subject resource. The “root_icon” column stores therein information indicating whether the resource, when being expanded and displayed on a resource map, is a root. In the example of FIG. 4, the term “true” is registered in the root-icon column for a resource being a root while the term “false” is registered in the column for a resource not being a root. The “parent_id” column stores therein the id of the parent resource of the subject resource.

The information to be registered into the respective columns of id, name, type, root_icon, and paretnt_id can be obtained from the network management information 12 in any known method.

The “filter” column stores therein information indicating the resource kind, and in the example of FIG. 4, either “physical” or “logical” is registered into the filter column. Specifically, the term “physical” is set for a physical resource and the term “logical” is set for a logical resource. Accordingly, it is possible to easily grasp whether the subject resource is a physical resource or a logical resource simply by referring the filter column.

Filtering with the values of the filter column makes it possible to easily extract only the physical resources or only the logical resources.

The “relative” column stores therein the id of each relative resource. Namely, information stored in the relative column represents another resource (relative resource) related to the subject resource.

In the displaying resource management table 23 of FIG. 4, the id of a logical resource is registered in the relative column of a physical subject resource; and the id of a physical resource is registered in the relative column of a logical subject resource.

For example, the number “10” is registered in the relative column of the physical resource “vm_guest1” having an id “1” in the displaying resource management table 23 illustrated in FIG. 4. The resource having the id “10” is “l_server1”, which is a logical resource, and the id “1” is registered in the relative column of the “l_server1”.

Here, a physical resource belongs to a displaying category of the physical configuration, and a logical resource belongs to a displaying category of the logical configuration.

As the above, the displaying resource management table 23 records multiple resources of the physical configuration and those of the logical configuration in association with each other.

The relative column stores therein only the id of the resource directly related to the subject resource but does not store therein the id of a resource related via multiple layer of the layer configuration of the network system 500, in other words, indirectly related, to the subject resource.

In the displaying resource management table 23, the correspondence between a physical resource and a logical resource can be easily grasped simply by referring to the relative column.

The displaying resource manager 21 refers to the displaying resource management table 23 and thereby specifies a logical resource (relative resource) related to a particular physical resource and also specifies a physical resource (relative resource) related to a particular logical resource.

Another resource associated with a particular resource obtained by referring to the relative column of the displaying resource management table 23 may sometimes be referred to as a relative resource.

The displaying resource manager 21 refers to the displaying resource management table 23 on the basis of a physical resource or a logical resource assigned by the operator through a physical map M1 and a logical map M2 as will be described below. Consequently, the displaying resource manager 21 functions as a specifier that specifies one or more relative resources (logical resources or physical resources) which are related to the assigned resource (focused resource; physical resource or logical resource).

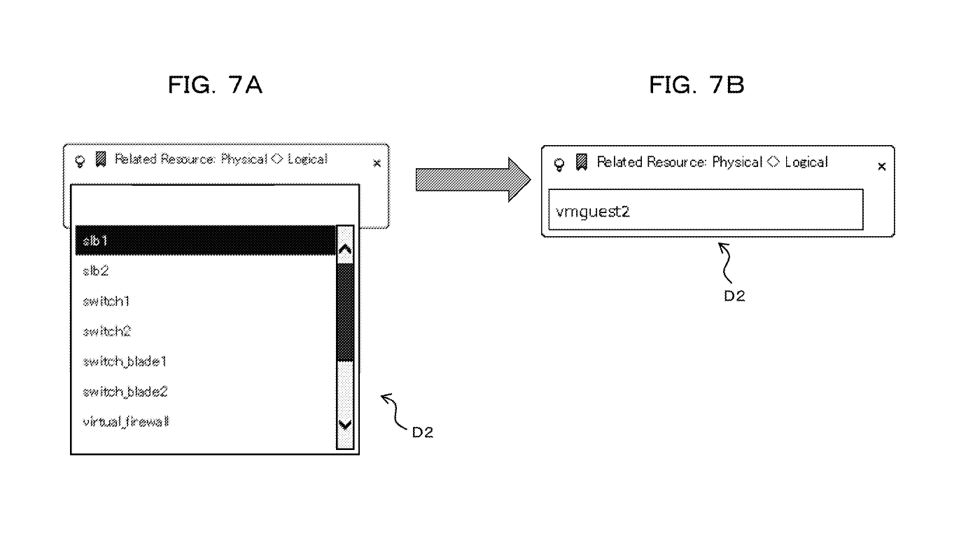

Namely, by referring to the resource management table 23, the displaying resource manager 21 specifies one or more logical resources (or one or more physical resources) associated with a physical resource (or logical resource) selected on a selector screen D2 (see FIGS. 7A and 7B) that is to be described below by the operator.

Specifically, the displaying resource manager 21 specifies one or more ids registered in the relative column of the selected resource by referring to the displaying resource management table 23, and reads the specified ids. For example, when one physical resource is assigned, the displaying resource manager 21 specifies (reads) the ids of one or more logical resources associated with the assigned physical resource by referring to the displaying resource management table 23.

In the above manner, the displaying resource manager 21 specifies one or more relative resources which are related to the focused resource assigned and which belong to the other displaying category (displaying resources; physical resources or logical resources).

Then, the displaying resource manager 21 notifies the ids of the specified (read) resources to the displaying controller 22.

The displaying controller 22 controls displaying of various pieces of information on the displaying device 204. Specifically, the displaying controller 22 controls displaying of the resource information of the network system 500 on the displaying device 204.

Here, the resource information of the network system 500 is information about the physical resources and the logical resources forming the network system 500, and specifically is the physical map and the logical map. Hereinafter, the physical map and the logical map are collectively referred to as the resource map.

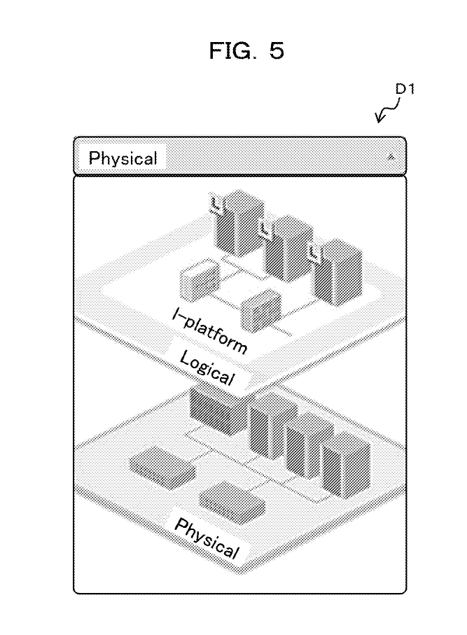

FIG. 5 is a diagram illustrating an example of an input screen displayed on the management system 1 of this embodiment, and specifically illustrates a selector screen D1 on which a physical map or a logical map is selected and the result of the selection is input.

The displaying controller 22 carries out control to display, on the displaying device 204, a selector screen D1 illustrated in FIG. 5 on which one of a physical map and a logical map is selected and the result of the selection is input.

The selector screen D1 of FIG. 5 causes the operator to select one of “Physical” and “Logical” from a pull-down menu. Through this process, the selector screen D1 switches the layer of the resource map to be displayed.

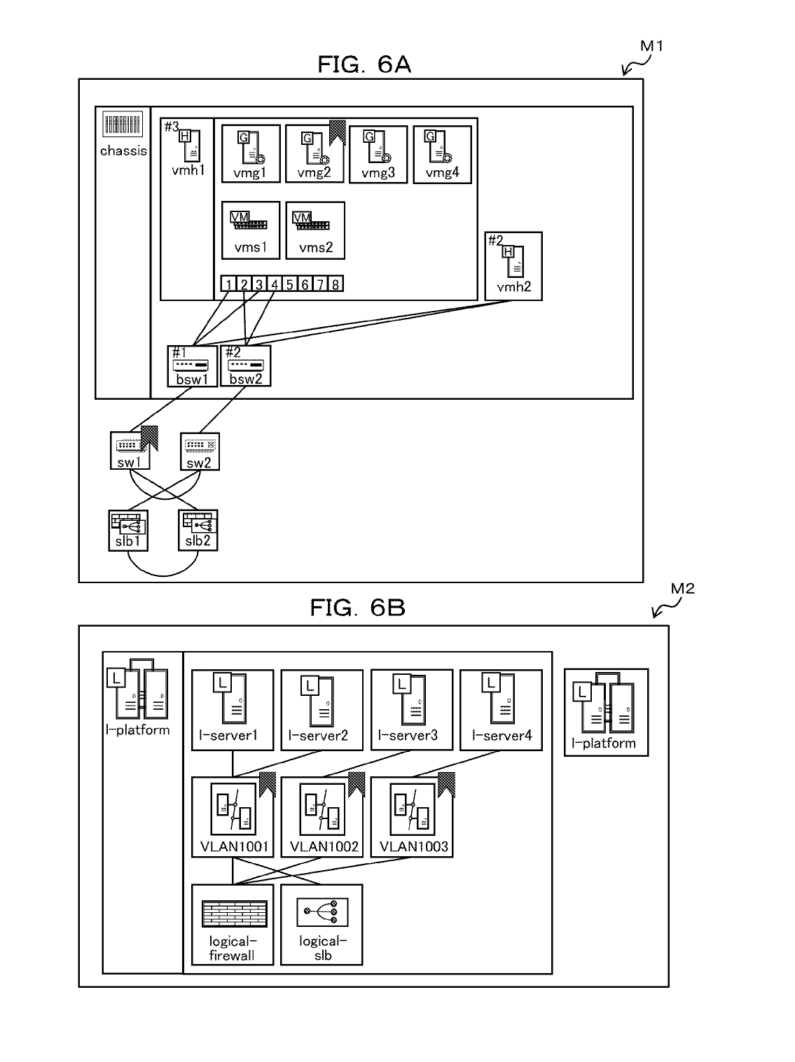

According to the result of the selection made on the selector screen D1, the displaying controller 22 carries out control to display, on the displaying device 204, a physical map M1 or a logical map M2 illustrated in FIGS. 6A and 6B, respectively.

As the above, the displaying category is selected via the selector screen D1 in the management system 1.

FIGS. 6A and 6B are diagrams each illustrating an example of a resource map displayed in the management system 1 of an example of this embodiment. Specifically, FIG. 6A illustrates a physical map M1 and FIG. 6B illustrates a logical map M2.

When “Physical” is selected on the selector screen D1 of FIG. 5, the displaying controller 22 displays the physical map M1 illustrated in FIG. 6A on the displaying device 204. In contrast, when “Logical” is selected on the selector screen D1 of FIG. 5, the displaying controller 22 displays the logical map M2 illustrated in FIG. 6B on the displaying device 204.

In response to alternative selection for the displaying category on the selector screen D1, the displaying controller 22 displays the resource map corresponding to the selected displaying category on the displaying device 204.

Various pieces of information, such as the physical configuration and the logical configuration of the network system 500 and icons representing respective resources, for displaying the physical map M1 and the logical map M2 can be obtained from, for example, management server 10 in any known manner.

Among resources illustrated in the physical map M1 or the logical map M2 displayed on the displaying device 204, the operator can assign (select) a particular physical or logical resource to be focused through input operation made on a selector screen D2 (FIGS. 7A and 7B) to be described below using the mouse 206 and/or the keyboard 205.

This causes the mouse 206 and/or the keyboard 205 to function as an inputting unit to input a resource assignment of a physical or logical resource to a resource to be focused among the physical or logical resources forming the network system 500.

Hereinafter, such a particular physical or logical resource that is to be focused and that is input on a selector screen D2 (see FIGS. 7A and 7B) to be described below may sometimes be referred to as a focused resource.

In the example of FIG. 6A, the icon representing the sw1 is marked with a ribbon shape to discriminate the sw1 from the remaining resources, and this ribbon mark indicates that the sw1 is a focused resource (to be detailed below).

The displaying controller 22 displays resources including a focused resource in a resource map (second resource map), connecting each resource to upper and/or lower resources thereof.

In FIG. 6B illustrating the logical map corresponding to FIG. 6A, the icons representing the VLAN1001 to VLAN1003 are marked with ribbon shapes to discriminate the VLANs from the remaking resources (to be detailed below). This ribbon marks indicates that the VLAN1001 to VLAN1003 are the relative resources related to the sw1.

The displaying controller 22 displays resources including a relative resource in a resource map (first resource map), connecting each resource to upper and/or lower resources thereof.

The marks attached to icon to indicate a focused resource and one or more relative resources are not limited to ribbon shapes, and various modifications can be suggested. For example, the mark attached to (emphasizing) the icon of the resource may be in another shape and/or may be colored.

In examples of FIGS. 6A and 6B, the ribbon marks are positioned on the upper right portions of the respective icons, but the positions are not limited to this. Alternatively, a mark may be attached to another position, such as an upper left, lower right, or lower left portion of each icon.

Further alternatively, the shape or the color of a corresponding icon may be changed instead of attaching a mark to the icon.

FIGS. 7A and 7B illustrate examples of an inputting screen displayed in the management system 1 of an example of this embodiment and specifically illustrate a selector screen D2 on which a focused resource is selected and the result of selection is input. FIG. 7A illustrates a state of selecting a resource, and FIG. 7B illustrates a state of fixing the selected resource. The example of FIGS. 7A and 7B assumes that a focused resource is selected from the physical resources.

The displaying controller 22 displays the selector screen D2 illustrated in FIGS. 7A and 7B to select a resource on the displaying device 204. The displaying controller 22 may display the selector screen D2 on the displaying device 204 displaying thereon also a resource map. That is, the selector screen D2 may be displayed along with a resource map.

As illustrated in FIG. 7A, the operator selects, using the mouse 206 and/or the keyboard 205, a particular resource (focused resource) from candidate resources displayed in the pull-down menu on the selector screen D2. After the particular resource is selected, the selected resource is extracted and displayed on the selector screen D2 as illustrated in FIG. 7B, so that the input is fixed.

When selection (input) for a focused resource is completed on the selector screen D2, the displaying controller 22 emphasizes the selected focused resource by attaching a mark as illustrated in FIG. 6A.

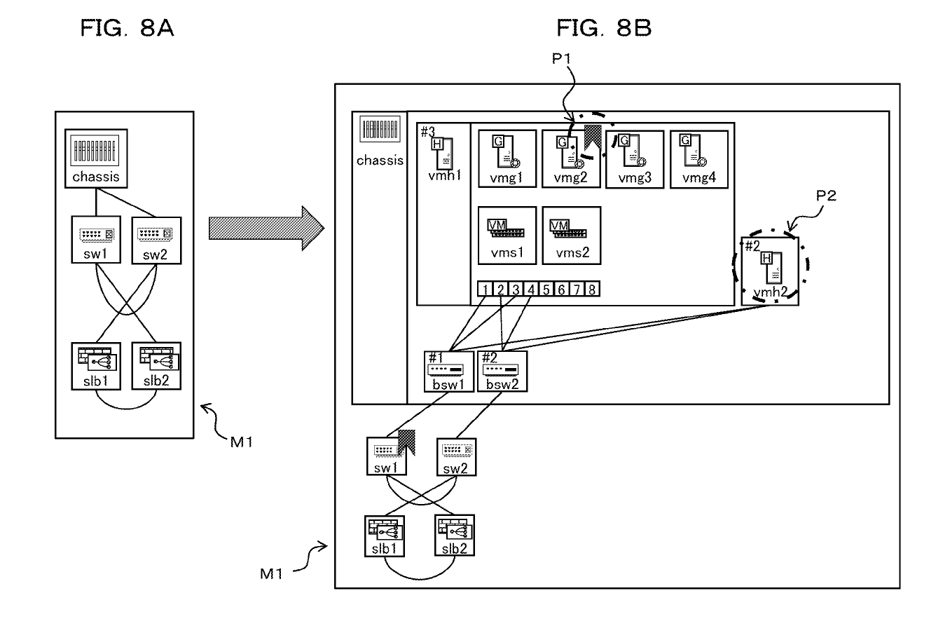

FIGS. 8A and 8B are diagrams illustrating examples of a resource map selected in the management system 1 of an example of this embodiment. Specifically, FIG. 8A illustrates a physical map M1 before a focused resource is selected and FIG. 8B illustrates a physical map M1 after the selection for a focused resource is completed.

When the operator selects, for example, vm_guest2 on the selector screen D2 illustrated in FIGS. 7A and 7B under a state where the physical map M1 illustrated in FIG. 8A is being displayed on the displaying device 204, the displaying controller 22 marks the icon (vmg2) corresponding to the selected vm_guest2 (focused resource) as illustrated in FIG. 8B (see reference number P1). This makes it possible to improve the visibility of the icon of each resource (relative resource) related to the focused resource on a resource map.

In the example of FIG. 8B, the displaying controller 22 marks the corresponding icon with a ribbon shape.

As illustrated in FIG. 8A, if the selected resource is not illustrated in the resource map displayed on the displaying device 204, the displaying controller 22 expands resource of the upper layer of the selected resource as illustrated in FIG. 8B until the selected resource appears.

For example, in the state of FIG. 8A, the icon (vmg2) representing the selected vm_guest2 selected on the selector screen D2 is not displayed. Therefore, the displaying controller 22 expands, as illustrated in FIG. 8B, the vmhost1 (vmh1) and the chassis, which are the upper resources of the selected vm_guest2, on the physical map M1 until the icon (vmg2) corresponding to the selected vm_guest2 is displayed.

Then the displaying controller 22 emphasizes the icon vmg2 appearing on the physical map M1 with a mark.

At this time, the displaying controller 22 does not expand a resource of an upper layer of a resource not selected by the user (operator) (see reference number P2). This can reduce the number of icons appearing on the displaying device 204 and enhance the visibility of the icon representing the selected resource.

In the resource map of FIG. 8B, also icon sw1 is marked. As this example, multiple resources may be selected.

As described above, the displaying resource manager 21 specifies one or more relative resources related to the focused resource selected on the selector screen D2 by referring to the displaying resource management table 23, and notifies the specified relative resources to the displaying controller 22.

The displaying controller 22 marks also each relative resource notified by the displaying resource manager 21 on the resource map on the same layer as the layer that the relative resource belong to.

Also in emphasizing each relative resource with a mark, if the relative resource is not illustrated on the displaying device 204 as illustrated in FIG. 8A, the displaying controller 22 expands resource of the upper layer of the relative resource likewise the example of FIG. 8B until the relative resource appears.

Specifically, the displaying controller 22 marks a focused resource selected on the selector screen D2 or each relative resource specified by the displaying resource manager 21 and displays the focused resource or the relative resource along with the attached mark on the resource map (physical map or logical map) of the layer (physical or logical) selected on the selector screen D1.

(B) Operation:

In the management system 1 of an example of this embodiment having the above configuration, when “Physical” is selected as a displaying layer on the selector screen D1 by the operator, the displaying controller 22 displays the physical map M1 on the displaying device 204. When the operator selects a physical resource on the selector screen D2, the displaying controller 22 marks the selected resource and displays the selected resource along with the attached mark on the physical map M1.

The displaying resource manager 21 specifies one or more logical resources (relative resources) associated with the physical resource (focused resource) selected on the selector screen D2 by referring to the displaying resource management table 23, and notifies the specified logical resources to the displaying controller 22.

After that, if the operator switches the displaying layer by selecting “logical” on the selector screen D1, the displaying controller 22 marks the logical resources (relative resources) specified by the displaying resource manager 21, and displays the specified logical resources along with the attached marks on the logical map M2.

In contrast, if “logical” is selected as the displaying layer on the selector screen D1, the displaying controller 22 displays the logical map M2 on the displaying device 204. After that, when the operator selects a logical resource on the selector screen D2, the displaying controller 22 marks the selected logical resource and displays the selected logical resource along with the attached mark on the logical map M2.

The displaying resource manager 21 specifies one or more physical resources associated with the logical resource selected on the selector screen D2 by referring to the displaying resource management table 23, and notifies the specified physical resources to the displaying controller 22.

Then, if the operator switches the displaying layer by selecting “physical” on the selector screen D1, the displaying controller marks the physical resources (relative resources) specified by the displaying resource manager 21, and displays the specified physical resources along with the attached marks on the physical map M1.

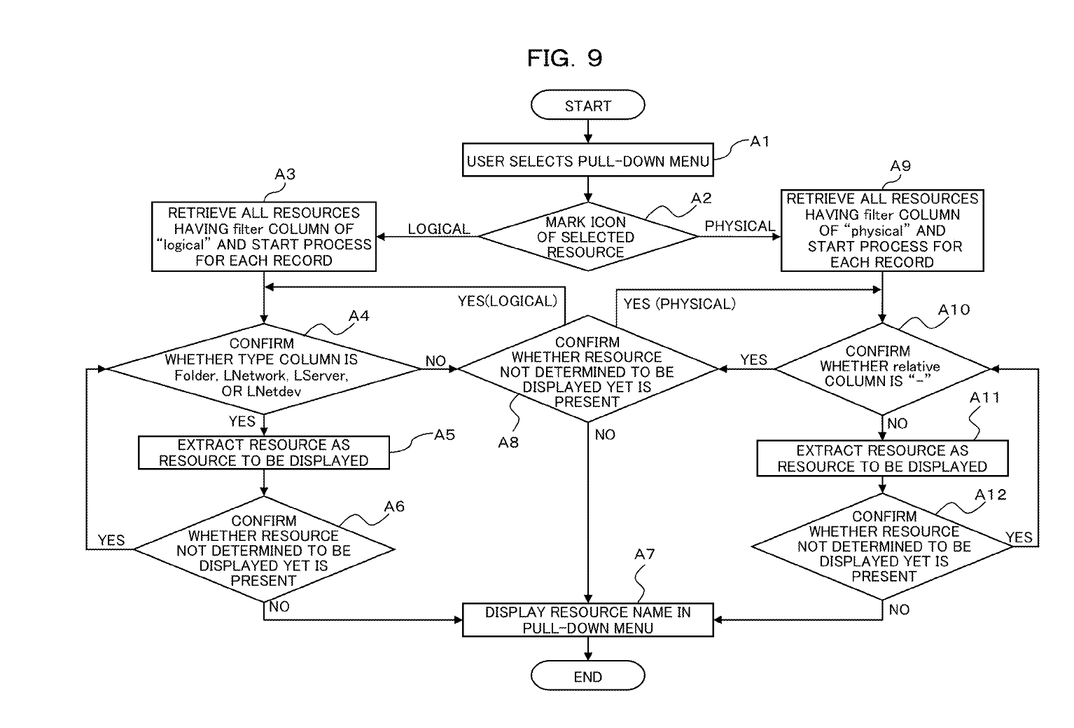

Next, description will now be made in relation to controlling displaying of the selector screen D1 by the displaying controller of the management system 1 of an example of this embodiment by referring to a flow diagram (steps A1-A12) of FIG. 9.

The following description assumes that, as illustrated in FIGS. 7A and 7B, selectable resource are displayed in a pull-down menu on the selector screen D2 to let the operator select a resource from the pull-down menu.

In step A1, the operator selects one from the physical map or the logical map on the selector screen D1 displayed on the displaying device 204. In other words, the operator selects one layer from the physical and logical layers and inputs the result of the selection.

In step A2, the displaying controller 22 confirms the selected layer. If the selected layer is the logical layer (see “logical” route of step A2), the process moves to step A3.

In step A3, the displaying resource manager 21 retrieves resources having a filter column of “logical” in the displaying resource management table 23, and extracts all the corresponding resources. Each of the extracted resources will be subjected to determination as to whether the resource is to be displayed as a candidate in the pull-down menu in the subsequent steps A4 and A5.

Specifically, in step A4, the displaying resource manager 21 confirms whether the type column of each extracted resource is “Folder”, “LNetwork”, “LServer”, or “LNetdev” in the displaying resource management able 23.

If the type column of an extracted resource is one of the above types (see YES route in step A4), the extracted resource is determined (further extracted) as a resource to be displayed in the pull-down menu in step A5.

In the next step A6, determination is made as to whether a resource not determined to be displayed in the pull-down menu yet is present among the resources extracted in step A3.

As a result of the confirmation, if a resource not determined to be displayed in the pull-down menu yet is present (see YES route in step A6), the process returns to step A4 and carries out steps A4 and A5 on the next resource.

In contrast, if no resource not determined to be displayed in the pull-down menu yet is present (see NO route in step A6), the displaying controller 22 displays one or more resources that are determined to be displayed in the pull down menu in step A7 and then finishes the process.

On the other hand, as the result of the confirmation of step A2, if the selected layer is the physical layer (see “physical” route of step A2), the process moves to step A9.

In step A9, the displaying resource manager 21 retrieves a resource having a filter column of “physical” in the displaying resource management table 23, and extracts all the corresponding resources. Each of the extracted resources will be subjected to determination as to whether the resource is to be displayed as a candidate in the pull-down menu in the subsequent steps A10 and A11.

Specifically, in step A10, the displaying resource manager 21 confirms whether the relative column of each extracted resource is “−” in the displaying resource management table 23.

As a result of the conformation, if the relative column of an extracted resource is not “−” (see NO route in step A10), the extracted resource is determined (further extracted) as a resource to be displayed in the pull-down menu in step A11.

In the next step A12, determination is made as to whether a resource not determined to be displayed in the pull-down menu yet is present among the resources extracted in step A9.

As a result of the confirmation, if a resource not determined to be displayed in the pull-down menu yet is present (see YES route in step A12), the process returns to step A10 and carries out steps A10 and A11 on the next resource.

In contrast, if no resource not determined to be displayed in the pull-down menu yet is present (see NO route in step A12), the displaying controller 22 displays one or more resources that are determined to be displayed in the pull down menu in step A7 and then finishes the process.

If the type column of an extracted logical resource is not any of the above types (see NO route in step A4) or if the relative column of an extracted physical resource is “−” (see YES route in step A10), the process is move to step A8. In step A8, determination is made as to whether a resource not determined to be displayed in the pull-down menu yet is present among the resources extracted in steps A3 and A9.

As a result of the confirmation, if a resource not determined to be displayed in the pull-down menu yet is present when the layer confirmed in step A2 is logical (see “YES (logical)” route of step A8), the process returns to step A4 and carries out steps A4 and A5 on the next resource. In contrast, if a resource not determined to be displayed in the pull-down menu yet is present when the layer confirmed in step A2 is physical (see “YES (physical)” route of step A8), the process returns to step A10 and carries out steps A10 and A11 on the next resource.

If no resource not determined to be displayed in the pull-down menu yet is present (see NO route of step A8), the displaying controller 22 displays one or more resources that are determined to be displayed in the pull down menu in step A7 and then finishes the process.

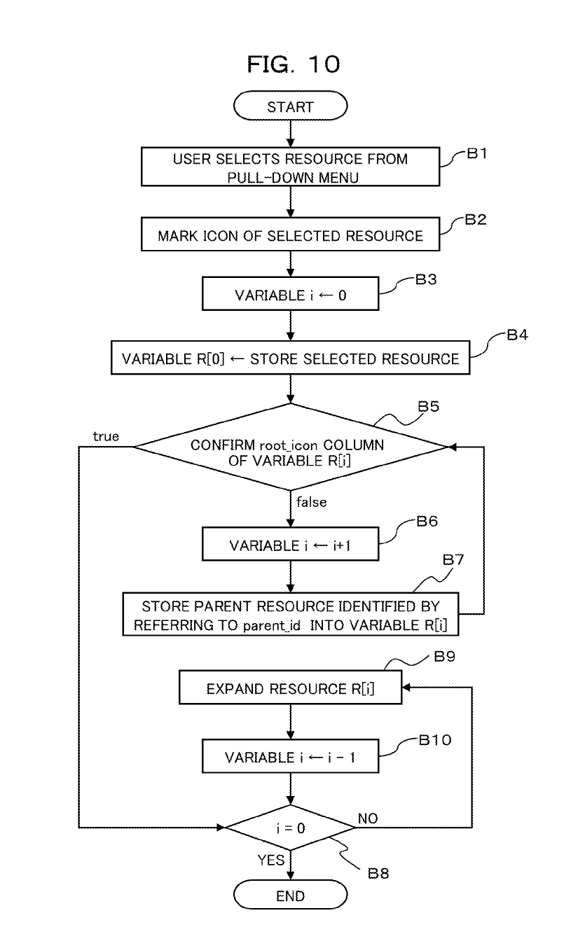

Next, description will now be made in relation to controlling displaying of a resource map by the displaying controller 22 in the management system 1 according to an example of this embodiment by referring to the flow diagram of FIG. 10 (steps B1-B10).

In step B1, the operator selects a resource and inputs the result of the selection on the selector screen D2 in the pull-down menu exemplified in FIGS. 7A and 7B.

In step B2, the displaying controller 22 marks the icon of the selected resource and displays the icon along with the attached mark. The information of the marked icon is retained in, for example, the browser. The displaying controller 22 stores the id of the selected resource into, for example, memory 202.

In step B3, after a variable i, which will be used as the counter, is initialized by setting zero therein, and the id of the resource selected in step B1 is stored in the variable R [i] in step B4. At this time point, since i=0, the id of the selected resource is stored in R [0].

In step B5, the displaying resource manager 21 confirms the root_icon column of the resource having an id of the value of the variable R [i] by referring to the displaying resource management table 23. This means that the resource to be processed is conformed to be a root.

As result of the conformation, if the roo_icon column is “false” (see the “false” route of step B5), the resource is not a root, but has a parent resource. In this case, the value of the variable i is updated in an increment of one (i=i+1) in step B6 and the process moves to step B7.

In step B7, the displaying resource manager 21 obtains the id of the parent resource of the resource selected in B1 by referring to the parent_id of the displaying resource management table 23 and stores the obtained parent resource into the variable R [i]. Then the process returns to step B5.

On the other hand, as result of the conformation of step B5, if the root_icon column is “true” (see the “true” route of step B5), the process moves to step B8. Whether i=0 is confirmed in step B8, and if i=0 (see YES route of step B8), the process is terminated.

Conversely, if i=0 is not established (see NO route of step B8), the process moves to step B9.

The displaying controller 22 expands the resource R [i] on the resource map in step B9, and in the ensuing step B10, updates the value of the variable i in decrement of one (i=i−1) and the moves the process to step B8.

The process of steps B8-B10 can sequentially expand and display, in regard to the resource selected by the operator, the root resource in an upper layer to the selected resource on the resource map.

Next, description will now be made in relation to controlling displaying of a resource map by the displaying controller 22 when the displaying layer is to be switched in the management system 1 of an example of this embodiment with reference to flow diagram of FIG. (steps C1-C11).

It is assumed that the processes of FIGS. 9 and 10 have been completed and the operator has selected a focused resource on the selector screen D2 (see step A1) before the following process is carried out.

In step C1, the operator (user) requests layer switching by selecting a layer of a resource map to be displayed on the displaying device 204 through the selector screen D1.

In the ensuing step C2, the displaying resource manager 21 specifies one or more relative resources of the focused resource selected in step A1 of FIG. 9 by referring to the relative column of the focused resource of the displaying resource management table 23.

The displaying controller 22 marks the respective icons of the specified relative resources on the resource map and thereby displays the icons along with the attached marks. Hereinafter, each relative resource attached thereto a mark is sometimes referred to as mark-attached resource. For example, the information of each marked icon are retained in, for example, a browser. The displaying controller 22 stores the id of each mark-attached resource into, for example, the memory 202.

In step C3, the displaying controller 22 confirms whether a displaying process on all the mark-attached resources is completed. If the displaying process on all the mark-attached resources is completed (see YES route of step C3), the displaying controller 22 finishes the process.

In contrast, if the displaying process on all the mark-attached resources is not completed (see NO route of step C3), the variable i is initialized by setting therein zero in step C4, and the id of a mark-attached resource specified in step C2 is stored in the variable R [i] in step C5. At this time point, since i=0, the id of a mark-attached resource is stored in R [0].

In step C6, the displaying resource manager 21 confirms the root_icon column of a resource having an id coinciding with the value of the variable R [i] by referring to the displaying resource management table 23. This step confirms whether the resource to be processed is a root.

As a result of the conformation, if the root_icon column is “false” (see the “false” route of step C6), the resource is not a root, but has a parent resource. In this case, the value of the variable i is updated in an increment of one (i=i+1) in step C7 and the process moves to step C8.

In step C8, the displaying resource manager 21 obtains the id of the parent resource of the specified mark-attached resource by referring to the parent_id column of the displaying resource management table 23 and stores the obtained parent resource into the variable R [i]. Then the process returns to step C6.

On the other hand, as result of the conformation in step C6, if the root_icon column is “true” (see the “true” route of step C6), the process moves to step C9. Whether i=0 is determined in step C9, and if i=0 (see YES route of step C9), the process returns to step C3.

Conversely, if i=0 is not established (see NO route of step C9), the process e moves to step C10.

The displaying controller 22 expands the resource R [i] on the resource map in step C10, and in the ensuing step C11, updates the value of the variable i in decrement of one (i=i−1) and the moves the process to step C9.

The process of steps C9-C11 can sequentially expand and display, in regard of each specified mark-attached resource, the root resource in an upper layer to the specified mark-attached resource on the resource map.

(C) Effects

In the management system 1 of an example of this embodiment, when the operator selects resource (focused resource) on the selector screen D2, the displaying controller 22 displays a resource map (second resource map, e.g., the physical map M1) on which the focused resource is marked (emphasized) on the displaying device 204.

The displaying resource manager 21 specifies one or more relative resources related to the focused resource by referring to the displaying resource management table 23.

In response to switching the layer of a resource map to be displayed on the displaying device 204 by the operator via the selector screen D1, the displaying controller 22 displays a resource map (first resource map, e.g., logical map M2) in which one or more relative resources are marked on the displaying device 204.

As the above, the correspondence between the focused resource and the one or more relative resources is visualized and thereby can be easily recognized by switching the layer of a resource map to be displayed on the displaying device 204 by the operator using the selector screen D1. Accordingly, the configuration of this embodiment can enhance the convenience.

In particular, even if the network system 500 includes large number of resources, the correspondence between a physical resource and a logical resource can be easily and visually grasped, which enhances the convenience.

If a failure occurs in a resource, the range of resources over which the failure affects can be visualized so that the operator can easily grasp the range. For example, assuming that an event (e.g., failure) occurs in a physical device, the management system 1 of an example of this embodiment makes the operator possible to visually confirm which logical system is to be affected by the event.

Furthermore, even if the network system 500 includes a large number of resources, it makes the operator possible to easily grasp a focused resource and each relative resource to the focused resource by displaying the icons of the focused resource and the relative resource along with marks.

The displaying controller 22 sequentially expands and displays, in regard to the focused resource selected by the operator, the root resource in an upper resource to the focused resource on the resource map, but does not expand the remaining resources. Even if the network system 500 includes a large number of resources, this configuration allows the operator to easily grasp the focused resource.

The displaying controller 22 sequentially expands and displays, in regard to each relative resource related to a resource selected by the operator, the root resource in an upper resource to the relative resource on the resource map, but does not expand the remaining resources. Even if the network system 500 includes a large number of resources, this configuration allows the operator to easily grasp each relative resource.

In response to switching the layer of a resource map to be displayed on the displaying device 204 by the operator using the selector screen D1, the layer of a resource map can be easily switched, so that, for example, a complicated physical configuration can be visualized into a simple logical map.

(D) Modification:

The above embodiment is merely exemplary and various changes and modification can be suggested without departing from the spirit of the embodiment.

For example, the above embodiment includes the displaying resource management table 23 having the relative column and registers the id of each resource being related to a subject resource and belonging to another layer, so that physical resources are is associated with logical resources. The method of association is not limited to this.

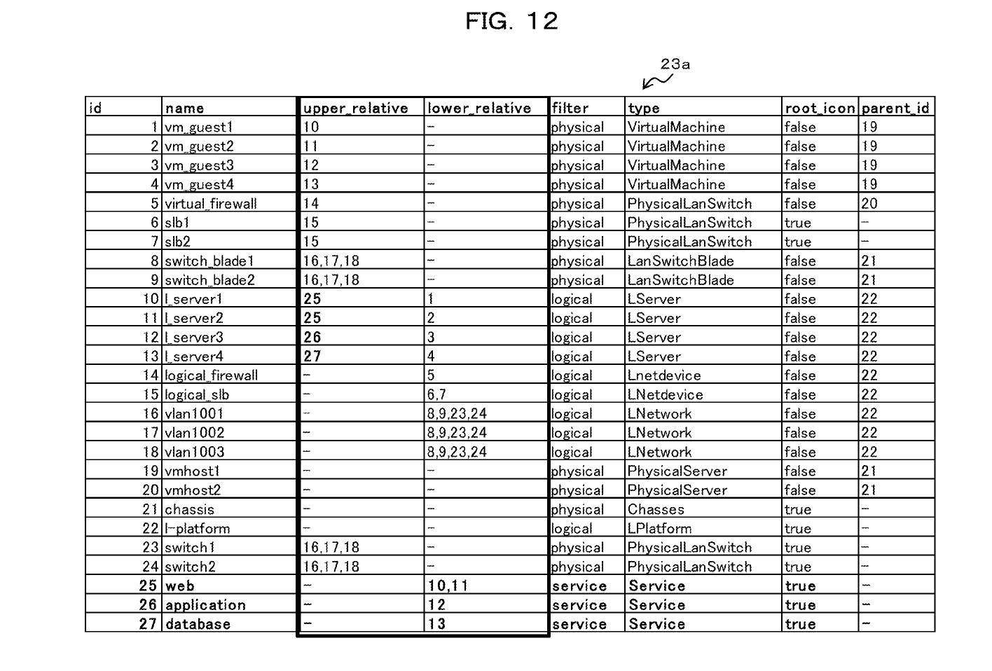

FIG. 12 is a diagram illustrating a displaying resource management table of the management system 1 according to a first modification of this embodiment.

A displaying resource management table 23a of FIG. 12 includes an upper_relative column and a lower_relative column instead of the relative column of the displaying resource management table 23 of FIG. 4.

Furthermore, in addition to the resource types “physical” and “logical”, another resource type “service” is registered in the filter column of the displaying resource management table 23a. Namely, this modification includes three layers of the physical layer, the logical layer, and the service layer.

For the resources having ids “25”-“27”, “web”, “application”, and “database” each having a filter column registered therein “service” are registered, respectively. The resources having ids “25”-“27” are registered in the upper_relative column of the resources having ids “10”-“13”, respectively.

The remaining part of the displaying resource management table 23a are the same as that of resource management table 23 of FIG. 4.

In the upper_relative column of the displaying resource management table 23a, information of a resource in an upper layer from the subject resource in the layered configuration of the network system 500 is registered. In contrast, the lower_relative column of the displaying resource management table 23a, information of a resource in a lower layer from the subject resource in the layered configuration of the network system 500 is registered.

In this modification, information stored in the upper_relative column and the lower_relative column are ids of only the resources directly related to the subject resource, but not ids of resources related to the subject resource via multiple layers, that is, ids of resources indirectly related to the subject resource.

As the above, the displaying resource management table 23a includes the upper_relative column and the lower_relative column in the first modification to the management system 1 of an example of the embodiment. Information of resources of the upper layer and the lower layer are stored in these columns, so that the information representing the correspondence of the upper and the lower sides of each resource can be further added.

This modification can obtain the same advantages as those of the above embodiment and further can manage three or more kinds of layer, which enhances the convenience.

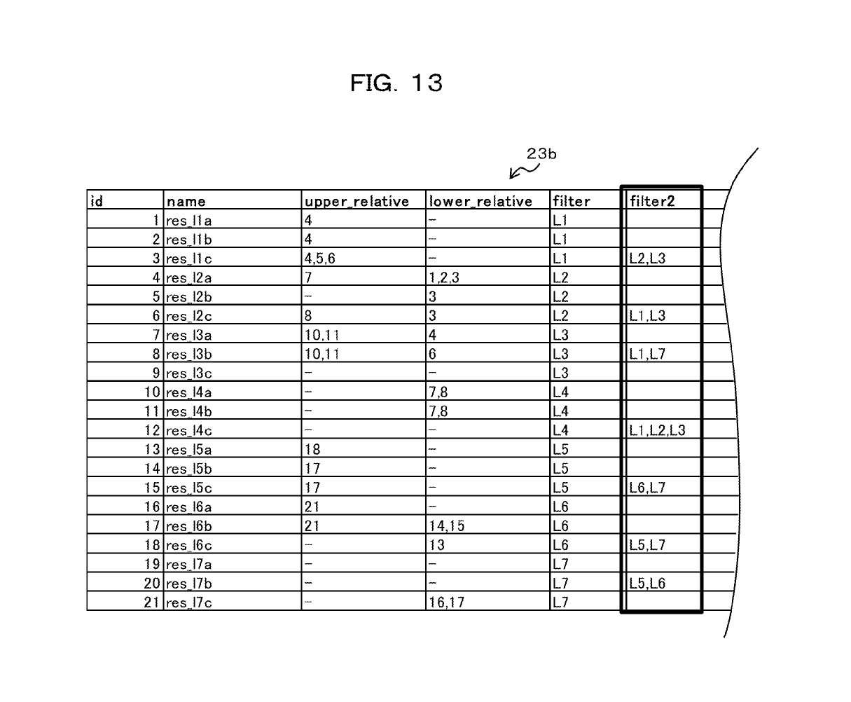

FIG. 13 is a diagram illustrating a resource management table according to a second modification of the management system 1 of an example of the above embodiment. FIG. 13 omits illustration of the root_icon column and the parent_id column for facilitating the table.

The displaying resource management table 23b illustrated in FIG. 13 further includes a “filter2” column in addition to the columns included in the displaying resource management table 23a illustrated in FIG. 12. In the filter column of the displaying resource management information 23b of FIG. 13, “L1”-“L7” are registered to manage seven layers. For example, the “L1”-“L7” corresponds to the respective layers of the ISO-OSI7 layer models.

This means that the second modification sets seven types of displaying categories of “L1”-“L7” and every resource belongs to one of the categories “L1”-“L7”.

A displaying category is selected from these layers of “L1”-“L7” on the management terminal 20, and the resources belonging to the selected displaying category can be selectively displayed.

The management terminal 20 can select any resource among multiple resources belonging to the displaying categories “L1”-“L7” as a focused resource.

The upper_relative column and the lower_relative column included in the displaying resource management tables 23a and 23b respectively illustrated in FIGS. 12 and 13 make it possible to manage the three or more layers.

Here, if the management system 1 is to manage many layers, the operator may wish to display resources belonging to a layer on a resource map in conjunction with another layer. For example, the resource “res_11c” having an id “3” in the displaying resource management table 23b belongs to the “L1” layer. When the operator wishes to display the resource “res_11c” along with the resources of the “L2” layer and the “L3” layer, “L2, L3” are registered into the filter2 column of the resource “res_11c”. This makes it possible to deal with the resource “res_11c” as the resources of the “L2” layer and the “L3” layer, and to display the resource “res_11c” in conjunction with the resources of the “L2” layer and the “L3” layer.

According to the second modification to the resource management table of the management system 1 of the example of the above embodiment, the presence of the filter2 column, corresponding to an extended form of the filter column, makes it possible to treat a resource the same as the resource of another layer. In other words, exceptionally treating of a resource is allowed and thereby the convenience is enhanced.

The displaying resource management table 23b of FIG. 13 includes two filter columns of “filter” and “filter2”. However, the filter columns are not limited to this modification. Alternatively, the displaying resource management table 23b may include three or more filter columns.

The above embodiment assumes that a physical resource is selected as a focused resource and a logical resource is relative resource. However, the focused and relative resources are not limited to this.

Alternatively, if a logical resource is selected as a focused resource and a physical resource is a relative resource, these resource can be processed in the same manner as performed in the above embodiment.

Furthermore, even when any of resources of “web”, “application”, “database” registered in the displaying resource management table 23a and resource of the displaying resource management table 23b of FIG. 13 may be a focused resource and a relative resource, these resource can be processed in the same manner as performed in the above embodiment.

In the above embodiment, the selector screens D1 and D2 take forms of pull-down menus, but are not limited to this.

Alternatively, the selector screen D1 may display thereon icons of the physical or logical as candidates for selection and may cause the operator to click a desired icon and thereby inputs the selection for the layer. The display manner on the selector screens D1 and D2 may be variously modified.

The selector screen D2 may be a resource map and the operator selects a focused resource by clicking the corresponding resource on the resource map. Further alternatively, the selector screen D2 may display thereon check boxes to select a focused display and may be further modified.

According to the above embodiment, the correspondence between resources of different displaying categories can be easily grasped.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein a resource displaying program causing a computer to execute a process comprising:
inputting an assignment of a resource belonging to a first displaying category to be focused among a plurality of resources belonging to each of a plurality of displaying categories, including the first displaying category and a second displaying category, to a focused resource, the first and the second displaying categories included in an information processing system;
specifying one or more relative resources which are related to the focused resource and which belong to the second displaying category by referring to resource information recording the plurality of resources belonging to the first displaying category and the plurality of resources belonging to the second displaying category of the information processing system in association with each other, using the focused resource; and
emphasizing the specified relative resources in a first resource map, the first resource map being displayed on a displaying device and connecting the plurality of resources belonging to the second displaying category.

2. The non-transitory computer-readable recording medium according to claim 1, wherein the process further comprises emphasizing the focused resource in a second resource map, the second resource map connecting the plurality of resources belonging to the first displaying category.

3. The non-transitory computer-readable recording medium according to claim 2, wherein the process further comprises displaying one or more resources forming the focused resource and elements forming an upper and/or a lower resources including the focused resource as a component in the second resource map.

4. The non-transitory computer-readable recording medium according to claim 1, wherein the process further comprises displaying one or more resources forming each of the relative resources and elements forming an upper and/or a lower resources including each of the relative resources as a component in the first resource map.

5. The non-transitory computer-readable recording medium according to claim 1, wherein
the plurality of displaying categories include a physical configuration and a logical configuration; and
the first resource map is a physical map or a logical map.

6. An information processing apparatus comprising:
an inputting unit that inputs an assignment of a resource belonging to a first displaying category to be focused among a plurality of resources belonging to each of a plurality of displaying categories, including the first displaying category and a second displaying category, to a focused resource, the first and the second displaying categories included in an information processing system;
a specifier that specifies one or more relative resources which are related to the focused resource and which belong to the second displaying category by referring to resource information recording the plurality of resources belonging to the first displaying category and the plurality of resources belonging to the second displaying category of the information processing system in association with each other, using the focused resource; and
a displaying controller that emphasizes the specified relative resources in a first resource map, the first resource map being displayed on a displaying device and connecting the plurality of resources belonging to the second displaying category.

7. The information processing apparatus according to claim 6, wherein the displaying controller emphasizes the focused resource in a second resource map, the second resource map connecting the plurality of resources belonging to the first displaying category.

8. The information processing apparatus according to claim 7, wherein the displaying controller displays one or more resources forming the focused resource and elements forming an upper and/or a lower resources including the focused resource as a component in the second resource map.

9. The information processing apparatus according to claim 6, wherein the displaying controller displays one or more resources forming each of the relative resources and elements forming an upper and/or a lower resources including each of the relative resources as a component in the first resource map.

10. The information processing apparatus according to claim 6, further comprising a storing device that stores therein the resource information.

11. The information processing apparatus according to claim 6, wherein:
the plurality of displaying categories include a physical configuration and a logical configuration; and
the first resource map is a physical map or a logical map.

12. A method for displaying a resource comprising:
inputting an assignment of a resource belonging to a first displaying category to be focused among a plurality of resources belonging to each of a plurality of displaying categories, including the first displaying category and a second displaying category, to a focused resource, the first and the second displaying categories included in an information processing system;
specifying one or more relative resources which are related to the focused resource and which belong to the second displaying category by referring to resource information recording the plurality of resources belonging to the first displaying category and the plurality of resources belonging to the second displaying category of the information processing system in association with each other, using the focused resource; and
emphasizing the specified relative resources in a first resource map, the first resource map being displayed on a displaying device and connecting the plurality of resources belonging to the second displaying category.

13. The method according to claim 12, further comprising emphasizing the focused resource in a second resource map, the second resource map connecting the plurality of resources belonging to the first displaying category.

14. The method according to claim 13, further comprising displaying one or more resources forming the focused resource and elements forming an upper and/or a lower resources including the focused resource as a component in the second resource map.

15. The method according to claim 12, further comprising displaying one or more resources forming each of the relative resources and elements forming an upper and/or a lower resources including each of the relative resources as a component in the first resource map.
